(19) United States
(12) Patent Application Publication
(10) Pub. No.: US 2013/0017611 A1
(43) Pub. Date: Jan. 17, 2013

(54) SENSOR MATERIAL AND METHOD FOR FABRICATING THE SAME AND DETECTING METHOD

(71) Applicants: Shou-Nan LI, Nantou County (TW); Hong-Ping LIN, Taipei City (TW); Hui-Ya SHIH, Changhua County (TW); Wen-An HSIEH, New Taipei City (TW); Jhih-Jie LIN, New Taipei City (TW)

(72) Inventors: Shou-Nan LI, Nantou County (TW); Hong-Ping LIN, Taipei City (TW); Hui-Ya SHIH, Changhua County (TW); Wen-An HSIEH, New Taipei City (TW); Jhih-Jie LIN, New Taipei City (TW)

(21) Appl. No.: 13/305,388

(22) Filed: Nov. 28, 2011

(30) Foreign Application Priority Data
Jul. 14, 2011 (TW) 100124879

(51) Int. Cl. G01N 21/62

(52) U.S. Cl. 436/73; 436/171; 436/103; 436/104; 436/127

(57) ABSTRACT

A method for fabricating a sensor material for detecting molecular contaminants, including the steps of: providing an aqueous solution of a metal oxide precursor; mixing titanium dioxide nanotubes with the aqueous solution of the metal oxide to form a mixture; adjusting a pH value of the mixture with a weak base until the pH value is neutral; dispersing the mixture in water and heating the mixture; and filtering the mixture to retain a solid part, and calcining the solid part under a continuous flow of oxygen to form metal oxide loaded titanium dioxide nanotubes. The disclosure also provides a sensor material and a detecting method using the sensor material for ppm-ppb-ppt concentration level detection of molecular contaminants.

### CROSS REFERENCE TO RELATED APPLICATIONS

This Application claims priority of Taiwan Patent Application No. 100124879, filed on Jul. 14, 2011, the entirety of which is incorporated by reference herein.

### BACKGROUND

1. Technical Field

The disclosure relates to a sensor material, and in particular relates to a sensor material capable of ppm-ppb-ppt concentration level detection, a fabricating method thereof, and a detecting method for detecting molecular contaminants using the sensor material.

2. Description of the Related Art

Gases used in semiconductor and optoelectronic manufacturing processes and by-products of these gases may become airborne molecular contaminants (AMC) that cause various product defects. The five categories of AMCs are molecular acids (MA), molecular bases (MB), molecular condensables (MC), molecular dopants (MD), and no classes (MO). For example, molecular acids may corrode metal layers, molecular bases may cause the damaging “T-topping” effect, molecular condensables may affect the characteristics of thin films by transforming Si—N bonding into Si—O bonding and may haze the photo lens of exposure machines, molecular dopants such as PH₃ and AsH₃ may shift the p-type and n-type properties, and ozone (O₃) of the no classes category may lower the capacitance of elements.

To prevent lowering yields in semiconductor and optoelectric manufacturing due to micro pollution, the International Technology Roadmap of Semiconductors (ITRS) suggests pollutant concentration limits for different line-width processes annually. As mentioned previously, PH₃ is one type of AMCs and is a colorless toxic gas at room temperature. When PH₃ is inhaled into the human body, a person may experience difficulty in breathing, and in some cases it may result in death. Thus, semiconductor plants are required to install PH₃ sensors by law. For example, for 45 nm processes, ITRS suggests that the concentration of PH₃ be lower than 10 parts per trillion (ppt). Therefore, it is necessary to use gas sensors with detection limits down to the ppt concentration level. Commercially available PH₃ sensors are mainly of two types—sensors that are based on the principle of electrochemical reactions, and sensors that are based on the principle of color changes. Together, these two types of sensors account for 90% of all sales. However, the lower limit of these commercially available PH₃ sensors is about 100-10 parts per billion (ppb), which is considerably higher than the 10 ppt limit required by today's standard. Currently, the method being used in the industry for molecular dopants detection is to first expose the wafers in a clean room for 24-48 hours, dissolve the deposited molecular dopants in hydrofluoric acid (HF) vapor to obtain a sample, and then analyze the sample with inductive coupled plasma mass spectroscopy (ICP-MS). However, this method is extremely time-consuming and labor-intensive, and each sample requires as long as 2-7 days for sampling and analysis. Thus, many days will have passed before wafer pollution is confirmed, and tens of thousands of wafers will have been polluted and have to be discarded, which could cause tremendous losses for semiconductor plants.

Therefore, a sensor material and a detecting method for detection of airborne molecular contaminants are needed.

### SUMMARY

The disclosure provides a method for fabricating a sensor material for detecting molecular contaminants, comprising the steps of: providing an aqueous solution of a metal oxide precursor; mixing titanium dioxide nanotubes with the aqueous solution of the metal oxide to form a mixture; adjusting a pH value of the mixture with a weak base until the pH value is neutral; dispersing the mixture in water and heating the mixture; and filtering the mixture to retain a solid part, and calcining the solid part under a continuous flow of oxygen to form metal oxide loaded titanium dioxide nanotubes.

The disclosure also provides a sensor material, comprising: titanium nanotubes; and metal oxide uniformly dispersed and loaded on the titanium dioxide nanotubes, wherein the metal oxide loaded titanium dioxide nanotubes have a BET of about 200-400 m²/g, and the atomic ratio of the metal in the metal oxide to titanium is about 10-50%.

The disclosure further provides a detecting method for detecting molecular contaminants, comprising: providing the sensor material; feeding a gas to react with the sensor material; and analyzing detection results with a Raman spectroscopy system or a Fourier transform infrared spectroscopy system.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a flowchart for fabricating a sensor material according to the embodiments of the disclosure;

FIG. 2 is a detecting system according to the embodiments of the disclosure;

FIGS. 3a-3b are the X-ray diffraction spectra obtained for different sensor materials fabricated according to embodiment 1 and examples 2-4;

FIG. 4 is the Raman spectrum obtained for embodiment 6 of the disclosure;

FIG. 5 is the FT-IR spectra obtained for embodiment 7 of the disclosure;

FIGS. 6-11 are the FT-IR spectra obtained for different sensor materials under different conditions in embodiment 8 of the disclosure;

FIGS. 12-14 are the FT-IR spectra obtained with different concentrations of gas to be detected (PH₃) in comparative example 5 of the disclosure; and

FIG. 15 is the FT-IR spectrum obtained for comparative example 6 of the disclosure.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The disclosure provides a method for fabricating a sensor material, wherein the sensor material is metal oxide loaded titanium dioxide nanotubes, and the metal oxide may comprise CuO, AgO, Au₂O₃, Fe₂O₃, or combinations thereof. The sensor material provided by the disclosure is used for detecting a gas, wherein the gas may comprise a phosphor-containing compound, AsH₃, B₂H₆, di(2-ethylhexyl)phthalate (DEHP), or combinations thereof. The phosphor-containing compound may comprise phosphine (PH₃), phosphoric acid (H₃PO₄), dimethyl methylphosphonate (DMMP), trimethyl phosphate (TMB), trimethyl phosphate (TMPO), or combinations thereof. In the embodiments of the disclosure, the sensor material detects the gas mainly through reactions between the gas and the metal oxide that is loaded on the sensor material.

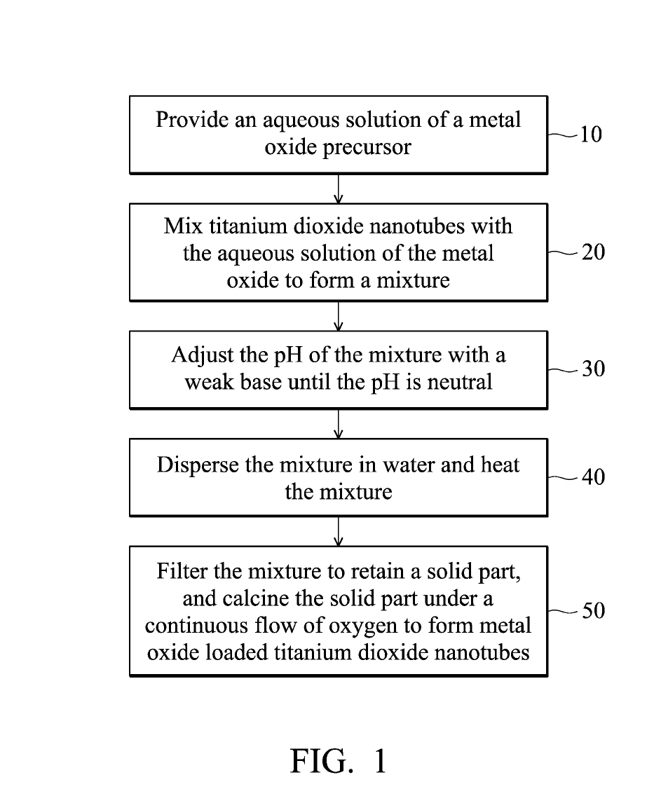

FIG. 1 is a flowchart for fabricating a sensor material according to embodiments of the disclosure. Step 10 is carried out first, wherein a solution of a metal oxide precursor is provided. In step 10, a suitable metal oxide precursor is chosen based on the metal oxide to be loaded on the titanium dioxide (TiO₂) nanotubes. For example, Cu(NO₃)₂ may be used as a precursor for CuO, AgNO₃ may be used as a precursor for AgO, Fe(NO₃)₃ may be used as a precursor for Fe₂O₃, and HAuCl₄ may be used as a precursor for AuO.

Step 20 is carried out next, wherein the metal oxide precursor solution is mixed with titanium dioxide nanotubes and or a solution of titanium dioxide nanotubes to form a mixture, wherein the molar ratio of mixing of the titanium dioxide nanotubes and the metal oxide precursor may be about 10:1 to 1:1. In some embodiments, the ratio may be 4:1. Furthermore, in some embodiments, high BET surface area titanium dioxide nanotubes (for example, titanium dioxide nanotubes with a BET area of about 200-400 m²/g) are applied to increase the loading of metal oxide on the titanium dioxide nanotubes (i.e. to increase the parts by weight of metal oxide loaded on the titanium dioxide nanotubes), which in turn, enhances the sensitivity of the sensor material. The aspect ratio of the titanium dioxide nanotubes may be about 1:35 to 1:160, and titanium dioxide crystal powder may be used as a precursor for synthesizing the titanium dioxide nanotubes. In an embodiment, titanium dioxide crystal powder is added into a basic solution, and the resultant mixture is then placed in a high temperature reactor for calcination. After the calcination, the resultant product is washed with acid and filtrated in order to complete the synthesis of the titanium dioxide nanotubes. It is understood that the aforementioned method for synthesizing the titanium dioxide nanotubes is merely exemplary, and any commercially available titanium dioxide nanotubes or titanium dioxide nanotubes synthesized by any methods may be used in the disclosure.

Then, step 30 is carried out, wherein a weak base is added into the mixture to adjust the pH value of the mixture until it is neutral, for example, the pH value may be about 6.5-7.5, or the pH value may be about 7. The weak base may be any organic or inorganic weak base such as Na₂CO₃, NH₃, C₆H₅NH₂, CH₃NH₂, CH₃CH₂NH₂, or combinations thereof. It is noted that in the embodiments of the disclosure, a weak base is used to adjust the pH value of the mixture instead of a strong base, this is because using a strong base may cause the local concentration of metal in the solution to be too high and thus form aggregation, and aggregation may, in turn, lower the loading and dispersity of the metal oxide.

Next, step 40 is carried out, wherein the mixture with its pH value adjusted to about neutral is dispersed in water and heated for hydrothermal ion intercalation so that the metal oxide may be uniformly dispersed and loaded on the surface of titanium dioxide nanotubes. It is noted that the inventors found that compared with carrying out hydrothermal ion intercalation directly without dispersion in water, carrying out water dispersion first and then hydrothermal ion intercalation, as in step 40, may enhance the dispersity of metal oxide in the synthesized sensor material. In some embodiments, the heating in step 40 is heating at 90-100° C. for 12-36 hours, or for 18-24 hours.

Step 50 is carried out after step 40. In step 50, the mixture is filtered to retain the solid part, which is titanium dioxide nanotubes loaded with both the metal oxide precursor and metal oxide, wherein a part of the metal oxide precursor has already been oxidized to metal oxide. The solid part is placed in a heating reactor, into which a continuous flow of oxygen is fed, for completely oxidizing the remaining metal oxide precursor loaded on the titanium dioxide nanotubes that has yet to be oxidized to metal oxide. The solid part undergoes calcination in the heating reactor to form metal oxide loaded titanium dioxide nanotubes, thus completing the fabrication of sensor material. The flow rate of oxygen fed into the heating reactor may be about 5-10 liters/mins, or may be about 5-6 liters/mins. In some embodiments, air may be continuously fed into the heating reactor during the calcinations of the solid part. In some embodiments, the calcination of the solid part is carried out at 250-350° C. for 3-9 hours, or for 3-6 hours. It is noted that the inventors found that in step 50, compared with calcining the solid part without feeding oxygen thereto, calcining the solid part under a continuous flow of oxygen may increase the dispersity of the metal oxide in the sensor material.

The BET surface area of the fabricated sensor material was measured to be about 114-165 m²/g, or 134-165 m²/g.

In the embodiments of the disclosure, the atomic ratio of the metal of the metal oxide to titanium may be about 10-50%, or 20-40%. However, the atomic ratio may be higher or lower in other embodiments.

The detecting method of the disclosure will be described below. Gas to be detected is passed from a gas tank 18, through a mass flow controller 38, into a mixing chamber 58, and compressed dry air is passed from a compressed dry air tank 28, through a chemical filter 48 and a mass flow controller 38′, into the mixing chamber 58 so that the gas to be detected and the filtered compressed dry air may be sufficiently mixed. The sufficiently mixed mixture of gas to be detected and filtered compressed air may be referred to as a gas mixture hereafter. The sensor material is placed in a testing chamber 68 in a way such that the sensor material lies flat on and covers the entire surface of the support platform. A gas mixture with a particular concentration of the gas to be detected is fed into the testing chamber 68 from the mixing chamber 58 at a particular flow rate so that the gas mixture can uniformly and thoroughly penetrate the sensor material. An analysis system 78 of a spectroscopy machine coupled with a reflective optical module that allows for continuous detection is connected to a testing chamber 68, and the analysis system 78 analyzes the light-absorbing characteristics at the surface of the sensor material. In some embodiments, an analysis system of a Raman spectroscopy system coupled with the reflective optical module that allows for continuous detection may be used. In other embodiments, an analysis system of a Fourier transform infrared spectroscopy (FT-IR) system coupled with the reflective optical module that allows for continuous detection may be used. In some embodiments, the reflective optical module may heat the gas mixture to shorten the detection time. The flow rate of the gas mixture fed into the testing chamber 68 may be about 1-30 liters/min. For example, the flow rate may be 1 liter/min, 15 liters/min, or 30 liters/min. The concentration of gas to be detected may be about 1000 ppb-100 ppt. For example, the concentration of gas to be detected may be 500 ppb, 200 ppb, 1 ppb, or 500 ppb. The sensor material provided by the disclosure has high capture efficiency, for example, a capture efficiency of over 98%, and may detect gas to be detected down to the ppt concentration level. The detecting method provided by the disclosure may be carried out for real time detection and results are obtained immediately.

In some embodiments, the sensor material provided by the disclosure (metal oxide loaded titanium dioxide nanotubes) has at least the following advantages: (1) high metal oxide dispersity and high metal oxide loading; (2) high capture efficiency for gas to be detected; (3) ppt concentration level detection; and (4) spectroscopically viable. Furthermore, the detecting method of the disclosure allows for real time detection of gas and requires a lower detecting temperature such as 60° C.

Various embodiments and comparative examples will be described below according to the fabrication method for the sensor and detecting method provided by the disclosure.

Method for Fabricating Sensor Material

### Embodiment 1: Copper Oxide Loaded Titanium Dioxide Nanotubes

(1) An amount of 0.625 g of titanium dioxide (Degussa P25) was added to the pre-mixed solution of 2.5 g NaOH in 12.5 ml deionized water, forming a mixture A.

(2) The mixture A from step (1) was placed into a high temperature reactor and was calcined for 24 hours.

(3) The heated mixture A was added to 1.3 ml of 70% HNO₃ and 200 ml of deionized water, stirred for 24 hours, and filtered twice.

(4) An amount of 0.625 g of titanium dioxide nanotubes fabricated by steps (1)-(4) above was added to 200 g of water to form a mixture B, and an amount of 0.156 g of Cu(NO₃)₂ powder was added to form an aqueous solution C.

(5) Mixture B and the aqueous solution C was mixed together to form a mixture D, and the mixture D was stirred at 40° C. for 3 minutes.

(6) 1M Na₂CO₃ solution was added to the stirred mixture D to adjust the pH value until the pH value was about 7.0.

(7) Mixture D that had a pH value of about 7 was dispersed in 100 g of water and was then heated at 100° C. for 24 hours.

(8) The heated mixture D of step (7) was filtered and dried to retain the solid part E.

(9) In an environment where air was continuously fed at a flow rate of 5 liters/min, the solid part was calcined to form copper oxide loaded titanium dioxide nanotubes, wherein the air fed was compressed dry air, which had been filtered by a chemical filter.

The BET surface area of the sensor material fabricated by the above steps (1)-(9) was measured and was found to be about 165 m²/g. The Cu loading of CuO in the sensor material fabricated in Embodiment 1 was measured with the combination of transmission electron microscopy and energy dispersive x-ray spectroscopy, and the atomic ratio of Cu/Ti was determined to be about 21%.

### COMPARATIVE EXAMPLE 1

### CuO Loaded Titanium Dioxide Nanotubes

Similar processes to that according to Embodiment 1 were performed except that in step (4), 0.156 g of Cu(NO₃)₂ powder was replaced with 0.031 g Cu(NO₃)₂ powder. The Cu loading of CuO in the sensor material fabricated in the Comparative Example 1 was measured with the combination of the transmission electron microscopy and energy dispersive x-ray spectroscopy, and the atomic ratio of Cu/Ti was determined to be about 5%.

### COMPARATIVE EXAMPLE 2

### pH Adjustment with a Strong Acid (NaOH)

Similar processes to that according to Embodiment 1 were performed except that in step (6), 1 M Na₂CO₃ solution was replaced with 0.6 M NaOH solution.

### COMPARATIVE EXAMPLE 3

### No Water Dispersion

Similar processes to that according to Embodiment 1 were performed except that in step (7), a mixture D that had a pH value of about 7 was not dispersed in 100 g of water and was directly heated at 100° C. for 24 hours.

### COMPARATIVE EXAMPLE 4

### Calcination of the Solid Part E in an Environment Where No Air is Fed Thereto

Similar processes to that according to Embodiment 1 were performed except that air was not passed through when calcining the solid part E.

The atomic ratio of Cu to Ti in the sensor materials fabricated in Comparative Examples 2-4 was about 21%.

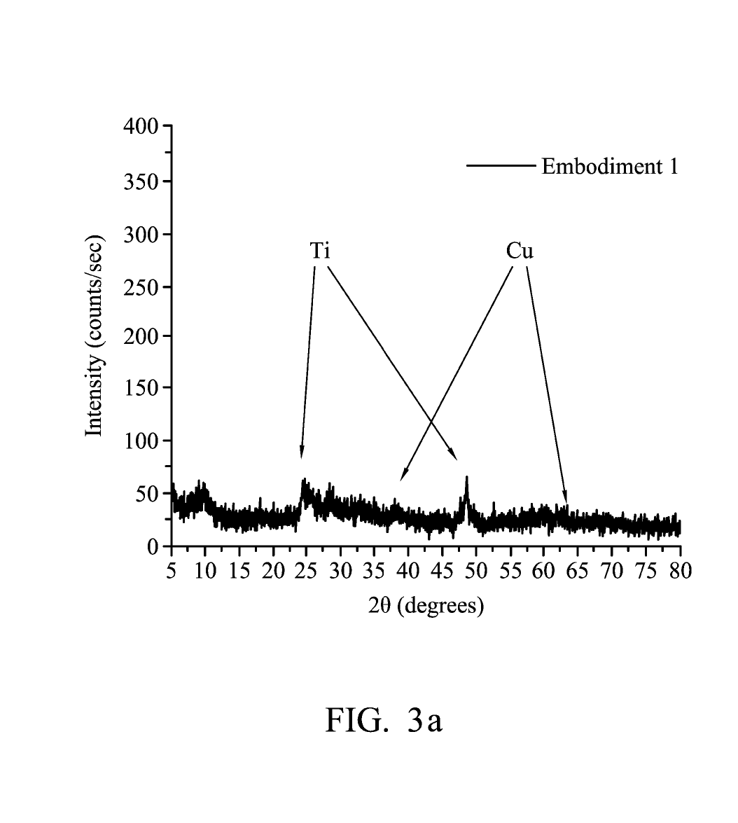

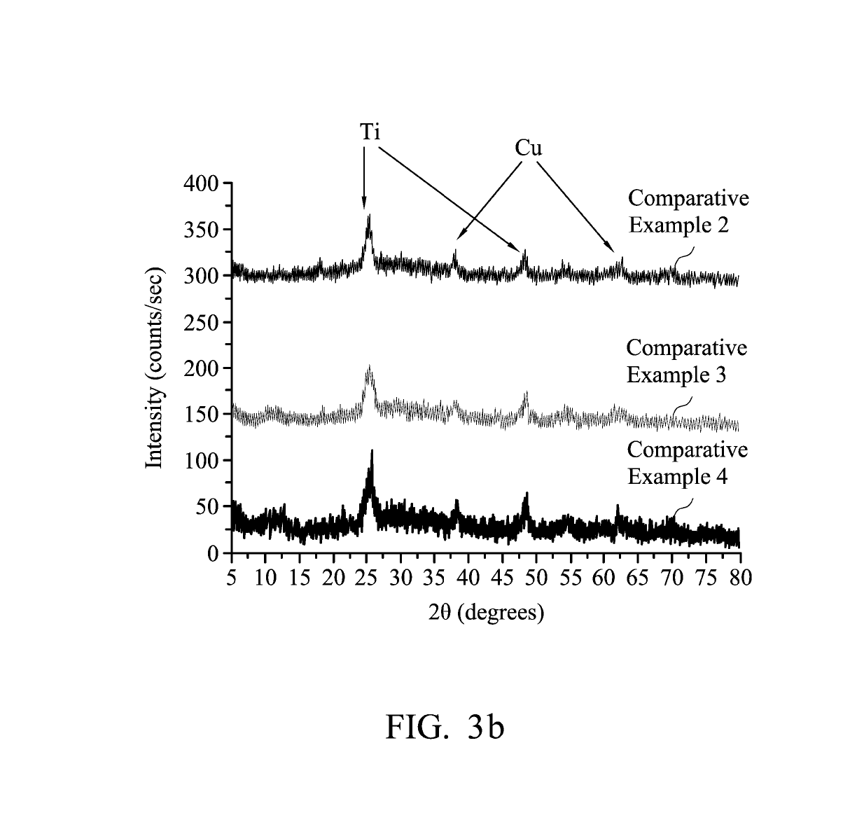

X-ray diffraction (XRD) was used to analyze the dispersity of the sensor materials fabricated by Embodiment 1 and Comparative Examples 2-4, and the results are shown in FIGS. 3a and 3b. FIG. 3a shows the XRD spectrum obtained for the sensor material fabricated by Embodiment 1, and FIG. 3b shows the XRD spectra obtained for different sensor materials fabricated by examples 2-4. If the dispersity of CuO is high, then the crystallinity of Cu is lower, resulting in smaller peaks in the XRD spectra. However, if the dispersity of CuO is low, then the crystallinity of Cu is higher, resulting in greater peaks in the XRD spectra. Referring to FIGS. 3a and 3b, the sensor material of Embodiment 1 has an extremely small Cu peak, indicating a high Cu dispersity, however, the sensor materials of Embodiments 2-4 have significantly larger Cu peaks in comparison, indicating a low Cu dispersity.

### Embodiment 2: AgO Loaded Titanium Dioxide Nanotubes

Similar process to that of Embodiment 1 were performed except that in step (4), 0.156 g of Cu(NO₃)₂ powder added into 10 g of water was replaced with 0.156 g of AgNO₃ powder added into 10 g of water.

The BET surface area of the fabricated sensor material was measured and was found to be about 110-160 m²/g. The Ag loading of AgO in the sensor material fabricated in Embodiment 2 was measured with the combination of transmission electron microscopy and energy dispersive x-ray spectroscopy, and the atomic ratio of Ag/Ti was determined to be about 23.2%.

### Embodiment 3: Fe₂O₃ Loaded Titanium Dioxide Nanotubes

Similar processes to that of Embodiment 1 were performed except that in step (4), 0.156 g of Cu(NO₃)₂ powder added into 10 g of water was replaced with 0.156 g of Fe(NO₃)₃ powder added into 10 g of water.

The BET surface area of the fabricated sensor material was measured and was found to be about 105-165 m²/g. The Fe loading of Fe₂O₃ in the sensor material fabricated in Embodiment 3 was measured with the combination of transmission electron microscopy and energy dispersive x-ray spectroscopy, and the atomic ratio of Fe/Ti was determined to be about 16.3%.

### Embodiment 4: CuO and Fe₂O₃ Loaded Titanium Dioxide Nanotubes

Similar process to that of Embodiment 1 were performed except that in step (4), 0.156 g Cu(NO₃)₂ powder added into 10 g of water was replaced with 0.140 g of Cu(NO₃)₂ powder and 0.0156 g Fe(NO₃)₃ powder added into 10 g of water.

The BET surface area of the fabricated sensor material was measured and was found to be about 105-165 m²/g. The Cu loading of CuO and Fe loading of Fe₂O₃ in the sensor material fabricated in Embodiment 3 were measured with the combination of transmission electron microscopy and energy dispersive x-ray spectroscopy, and the atomic ratios of Cu/Ti and Fe/Ti were determined to be about 19% and 1.5%, respectively.

### Embodiment 5: AuO Loaded Titanium Dioxide Nanotubes

Similar process to that of Embodiment 1 were performed except Cu(NO₃)₂ was replaced with HAuCl₄.

The BET surface area of the fabricated sensor material was measured and was found to be about 105-165 m²/g. The Au loading of AuO in the sensor material fabricated in Embodiment 5 was measured with the combination of transmission electron microscopy and energy dispersive x-ray spectroscopy, and the atomic ratio of Au/Ti was determined to be about 11.6%.

Detecting Method of Gas to be Detected

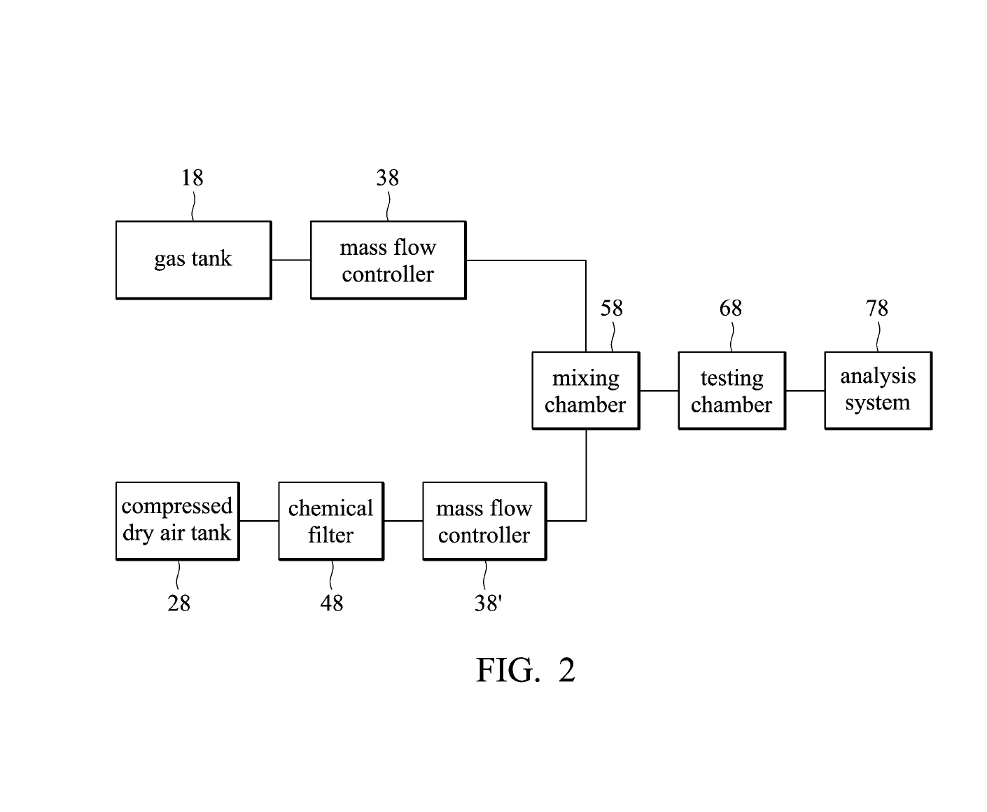

A detecting system as shown in FIG. 2. was provided. Gas to be detected was passed from a gas tank 18, through a mass flow controller 38, into a mixing chamber 58, and compressed dry air was passed from a compressed dry air tank 28, through a chemical filter 48 and a mass flow controller 38′, into the mixing chamber 58 such that the gas to be detected and filtered compressed dry air were sufficiently mixed to form a gas mixture. The sensor material fabricated by the embodiments and/or comparative examples of the disclosure was placed in the testing chamber 68 in a way such that the sensor material lied flat on and covered the entire surface of the support platform. A gas mixture with a particular concentration of the gas to be detected was fed into the testing chamber 68 from the mixing chamber 58 at a particular flow rate so that the gas mixture uniformly and thoroughly penetrated the sensor material. An analysis system 78 of a spectroscopy machine coupled with a reflective optical module that allows for continuous detection was connected to a testing chamber 68 to analyze the light-absorbing characteristics at the surface of the sensor material.

To ensure that the sensor material provided by the disclosure has high capture efficiency, a Drager sensor hydrude was connected to the testing chamber. The gas mixture was fed into the testing chamber, in which the sensor material of Embodiment 1 was placed, at a flow rate of 1 liter/min, and the concentration of gas to be detected (PH₃) was 500 ppb. The Drager sensor hydrude was used to detect the concentration of gas to be detected in the gas mixture that was passed out from the testing chamber, and the concentration was found to be below the lower limit of the Drager sensor hydrude (10 ppb), proving that the sensor material provided by the Embodiments of the disclosure has a high capture efficiency of over 98%.

### Embodiment 6

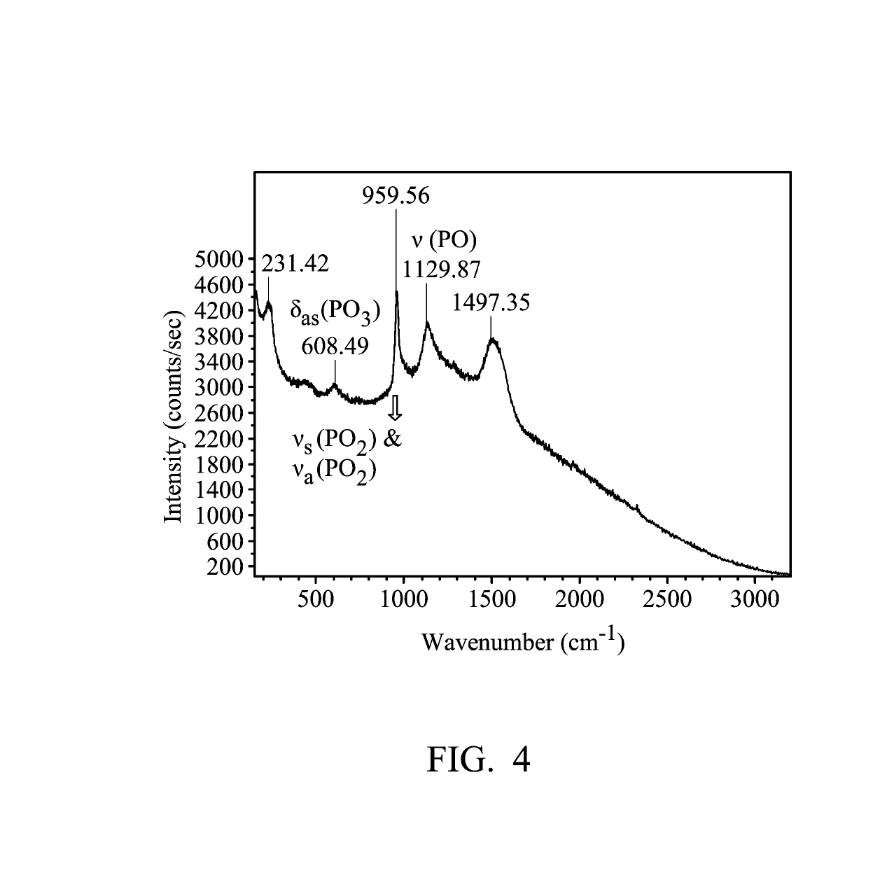

In Embodiment 6, the sensor material fabricated in Embodiment 2 was used and phosphine was the gas to be detected. The flow rate of the gas mixture was 1 liter/min, and the PH₃ concentration was 500 ppb. A Raman spectroscopy machine coupled with a reflective optical module was used to analyze light-absorbing characteristics at the surface of the sensor material while the gas mixture was passed into the testing chamber. In this embodiment, if P—O bondings were formed as a result of reactions between phosphine and the sensor material in the testing chamber, these bondings would have been detected by the Raman spectroscopy machine. FIG. 4 shows the Raman spectrum obtained for Embodiment 6 of the disclosure. In FIG. 4, a characteristic peak is observed at 956±2 cm⁻¹, and this characteristic peak may be used for qualitative and quantitative analysis of phosphor-containing compounds (such as PH₃).

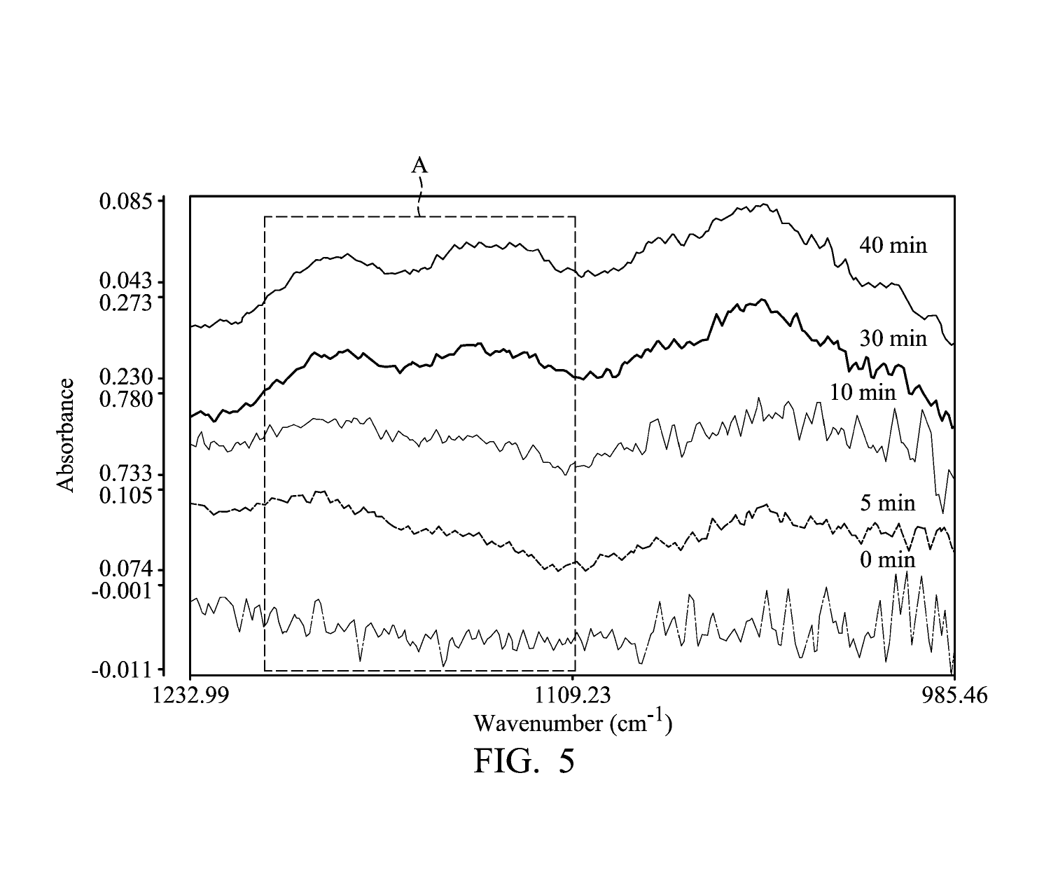

In Embodiment 7, the sensor material fabricated in Embodiment 1 was used, and phosphine was the gas to be detected. The sensor material was heated at 60° C., and the gas mixture was passed into the testing chamber continuously with a flow rate of 1 SLM (standard liter per minute) and a PH₃ concentration of 1 ppm. A FT-IR spectroscopy machine coupled with a reflective optical module was used to analyze light-absorbing characteristics at the surface of the sensor material at different time intervals while the gas mixture was passed into the testing chamber continuously. Similarly, in this embodiment, if P—O bondings were formed as a result of reactions between phosphine and the sensor material in the testing chamber, these bondings would have been detected by the FT-IR spectroscopy machine. FIG. 5 is the FT-IR spectra obtained at 0, 5, 10, 30, and 40 minute intervals, and a region A as shown in FIG. 5 is the characteristic peak region for P—O bonding. As shown in FIG. 5, the P—O bonding characteristic peak was observed in 5 minutes, and as testing time progressed, the P—O bonding characteristic peak increased. Therefore, in this embodiment, phosphine gas at a ppm concentration level was detected.

### Embodiment 8

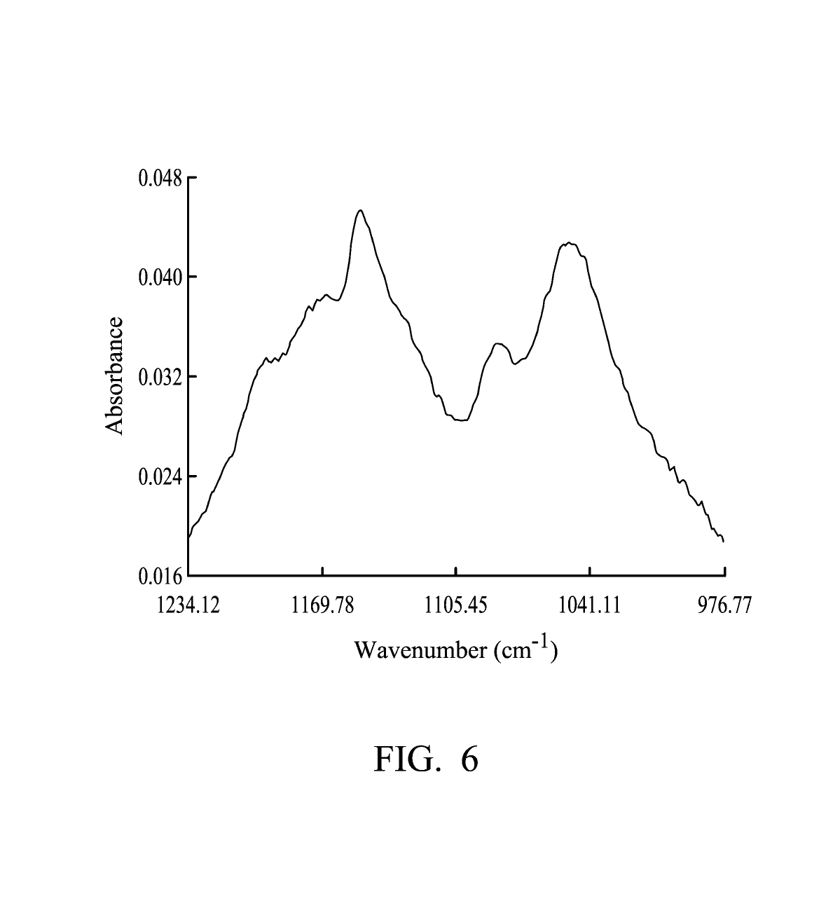

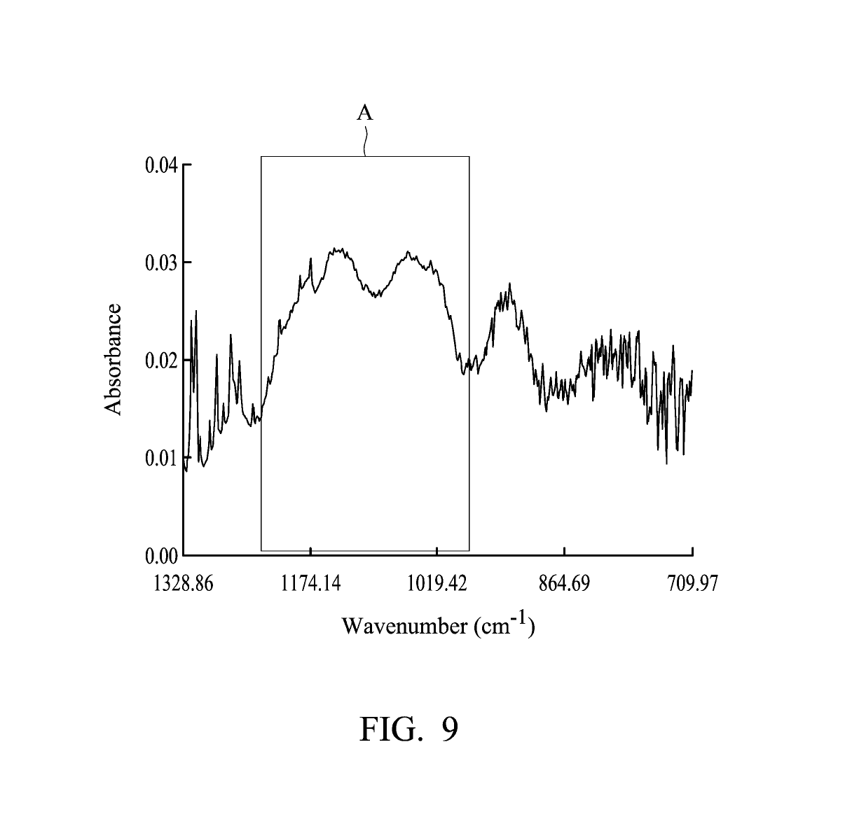

In Embodiment 8, phosphine was the gas to be detected and a FT-IR spectroscopy machine coupled with a reflective optical module was used to analyze light-absorbing characteristics at the surface of the sensor material while the gas mixture was passed into the testing chamber. Referring to Table 2, it tabulates the different detecting conditions employed with the use of different sensor materials, and the resultant FT-IR spectra are shown in FIGS. 6-11, from which the P—O bonding characteristic peaks are easily distinguished and analyzed. For example, in FIGS. 9-11, a region A as shown is the characteristic peak region for P—O bondings. Therefore, in this embodiment, phosphine gas at a ppt concentration level was detected.

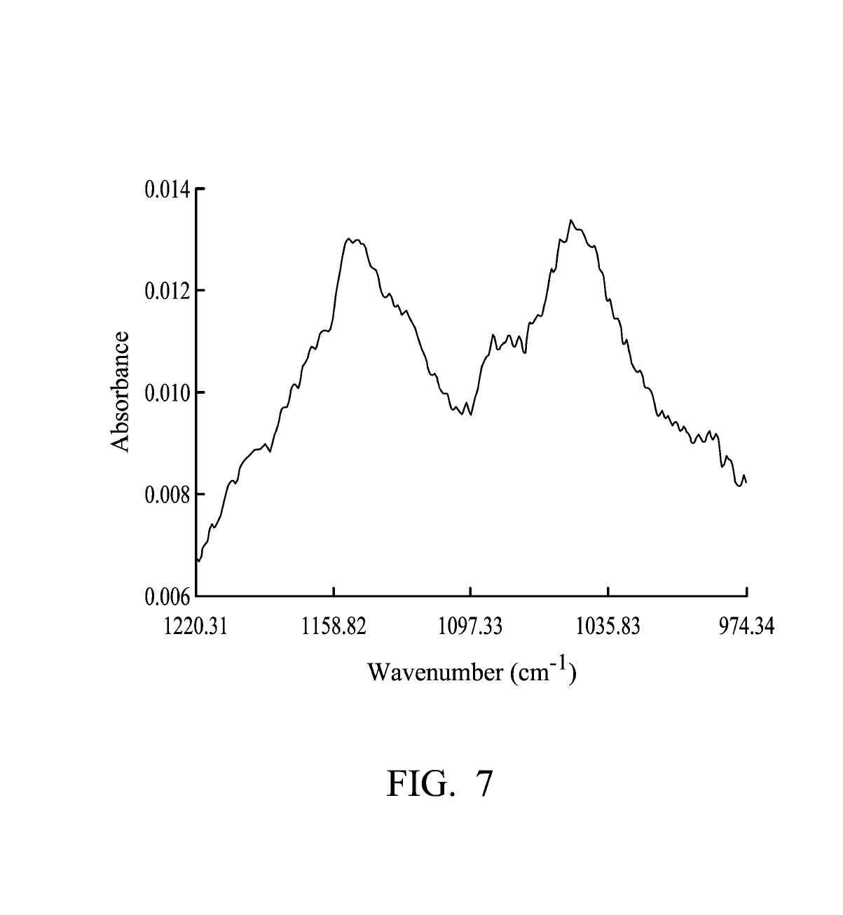

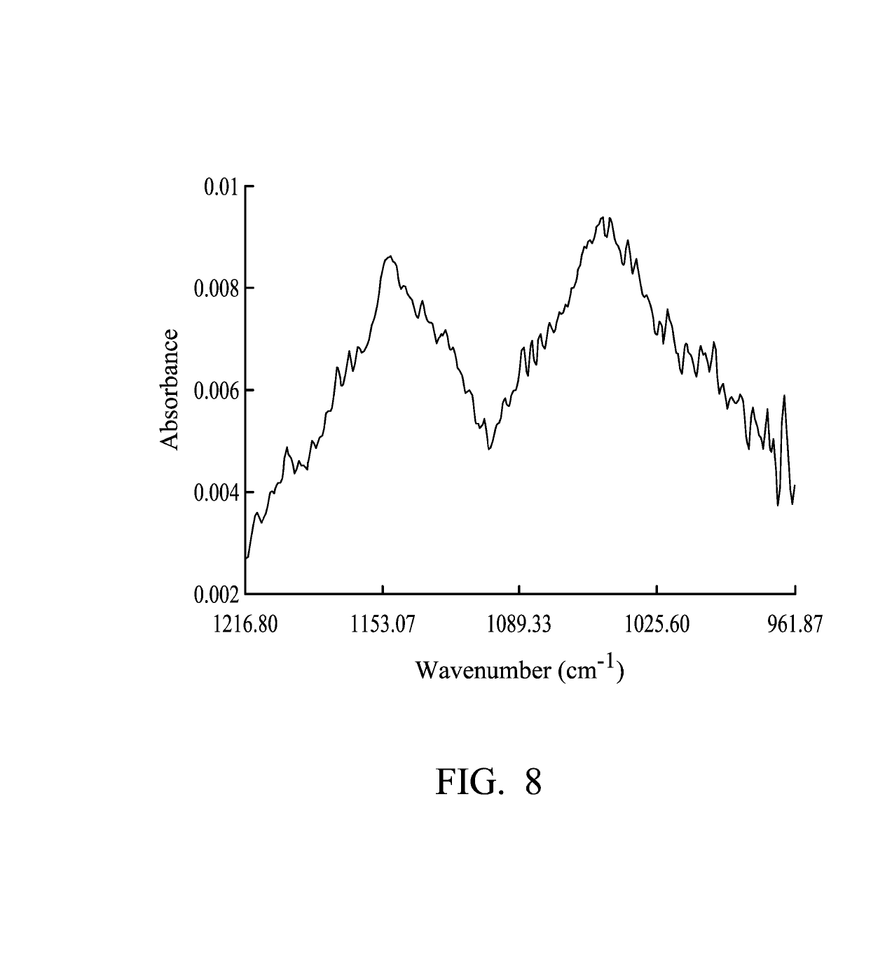

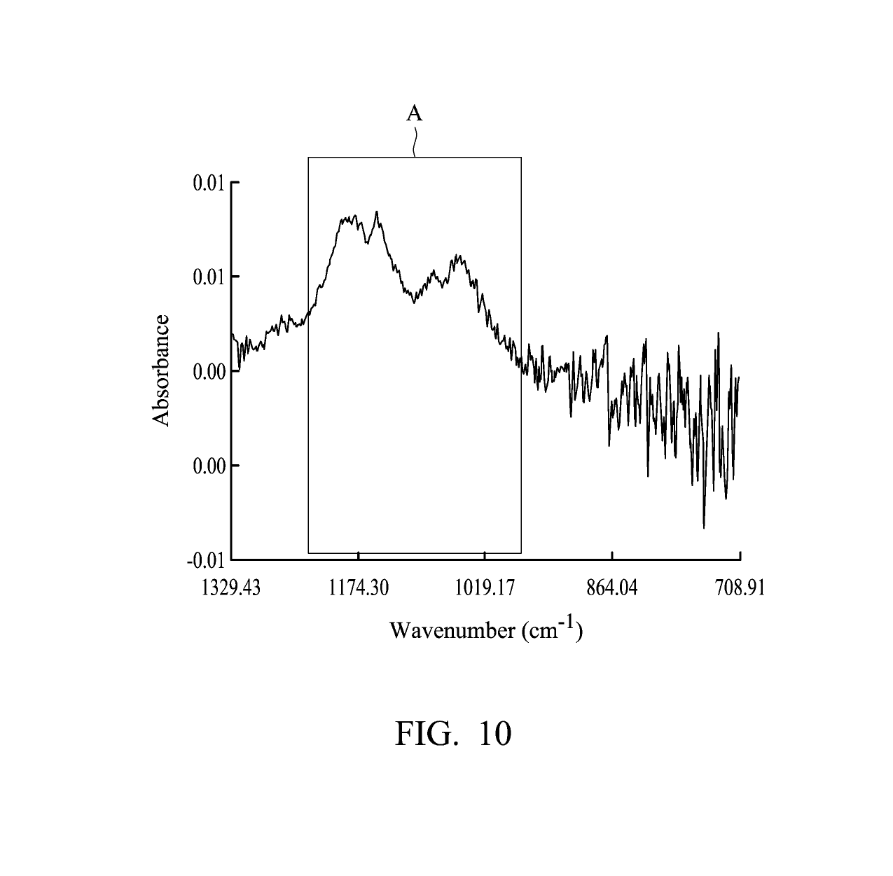

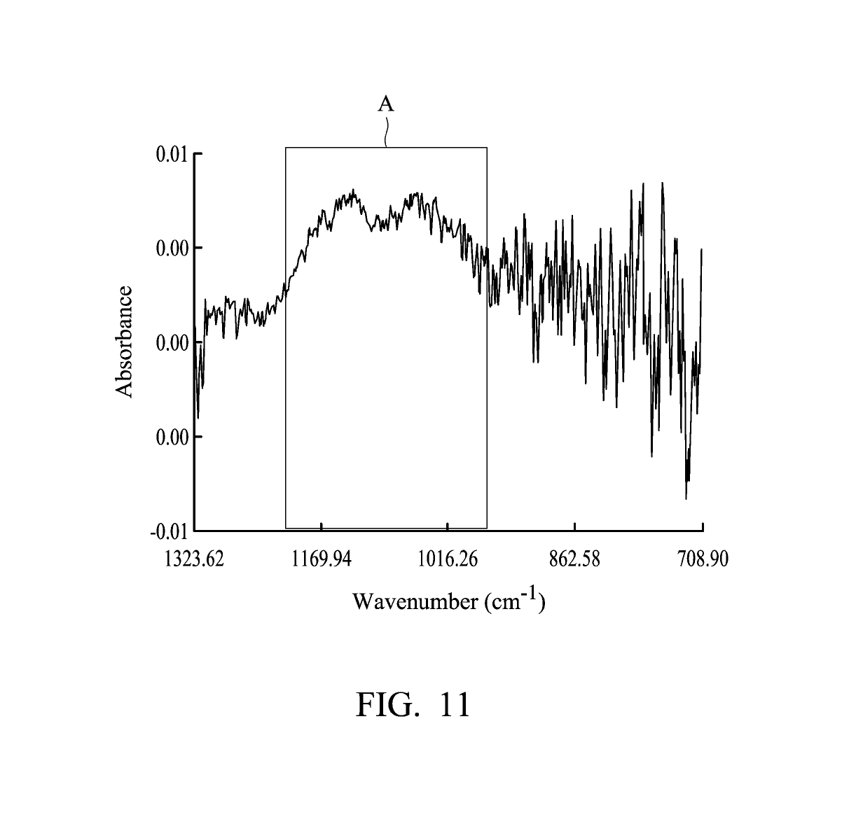

TABLE 2

| | Gas mixture flow rate | Conc. of gas to be | |
|---|---|---|---|
| Sensor material | (liters/min) | detected (PH₃) | Spectra |
| Embodiment 1 | 10 | 500 ppb | FIG. 6 |
| Embodiment 1 | 10 | 1 ppb | FIG. 7 |
| Embodiment 1 | 10 | 500 ppt | FIG. 8 |
| Embodiment 2 | 10 | 100 ppb | FIG. 9 |
| Embodiment 4 | 10 | 100 ppb | FIG. 10 |
| Embodiment 5 | 10 | 100 ppb | FIG. 11 |

Therefore, as described in Embodiments 7-8, the sensor materials fabricated by the disclosure may detect PH₃ gas at ppm, ppb, and ppt levels.

### COMPARATIVE EXAMPLE 5

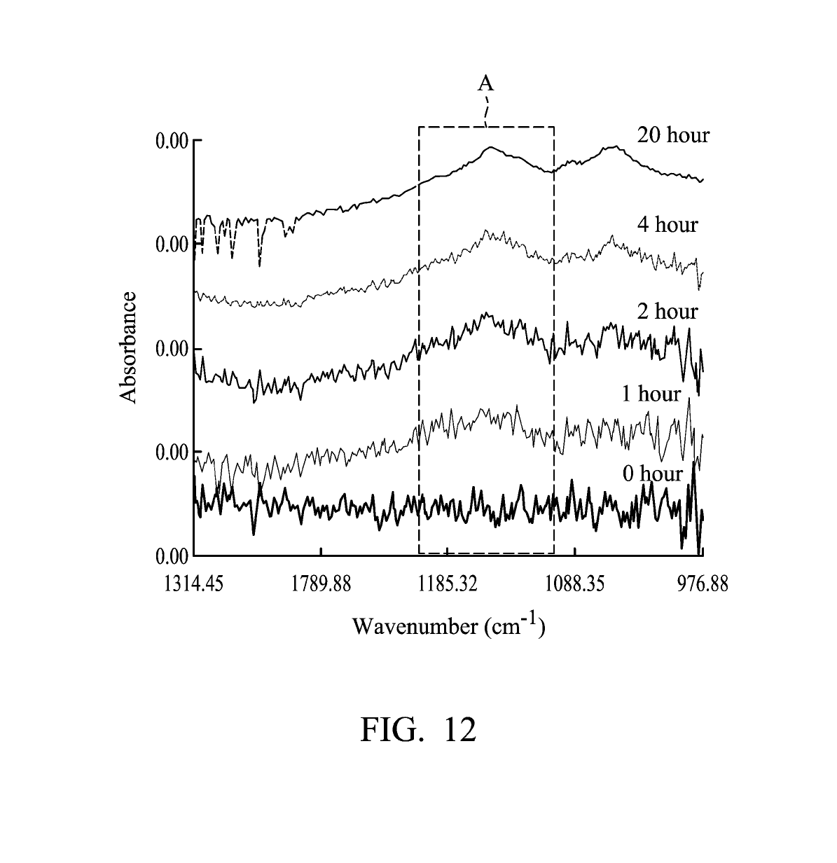

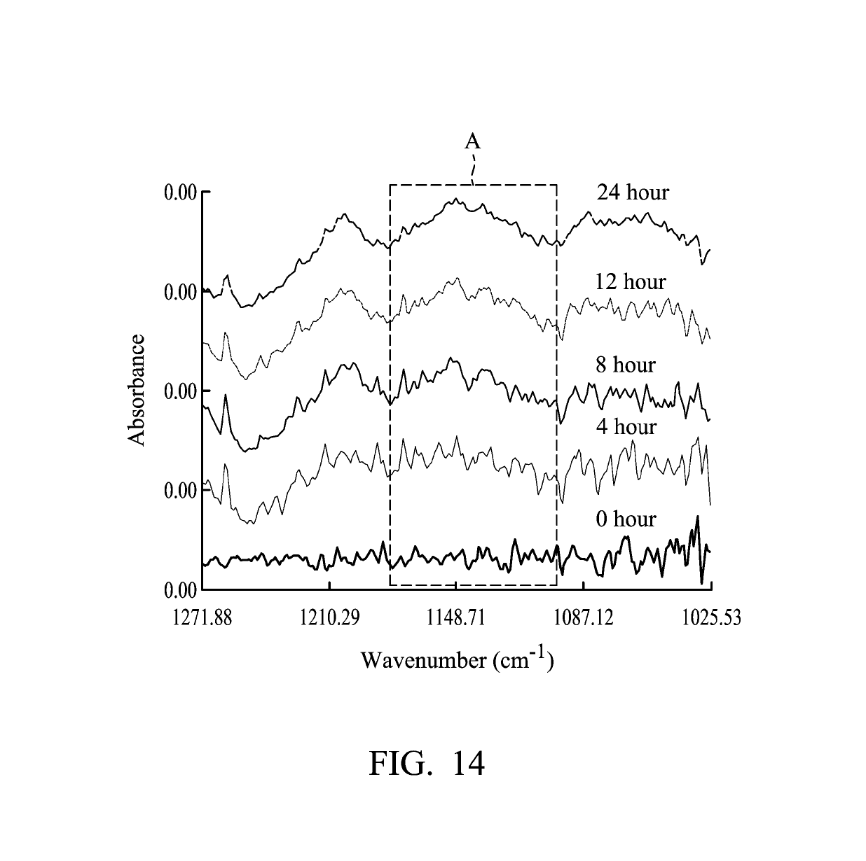

Similar processes to that of Embodiment 8 were performed, except that the gas mixture was fed into the testing chamber for 20 or 24 consecutive hours for detection, and the FT-IR spectra were obtained at different time intervals. Table 3 shows the different conditions employed, and from the spectra shown in FIGS. 12-14, significant changes in the absorption intensity between 900-1200cm⁻¹ were observed. Similarly, in FIGS. 12-14, a region A as shown is the characteristic peak region for P—O bondings. Furthermore, Table 4 shows the signal-to-noise ratio (S/N) of the spectrum shown in FIG. 14, and since S/N increased gradually over time, it is understood that the sensor material continuously absorbed the gas to be detected.

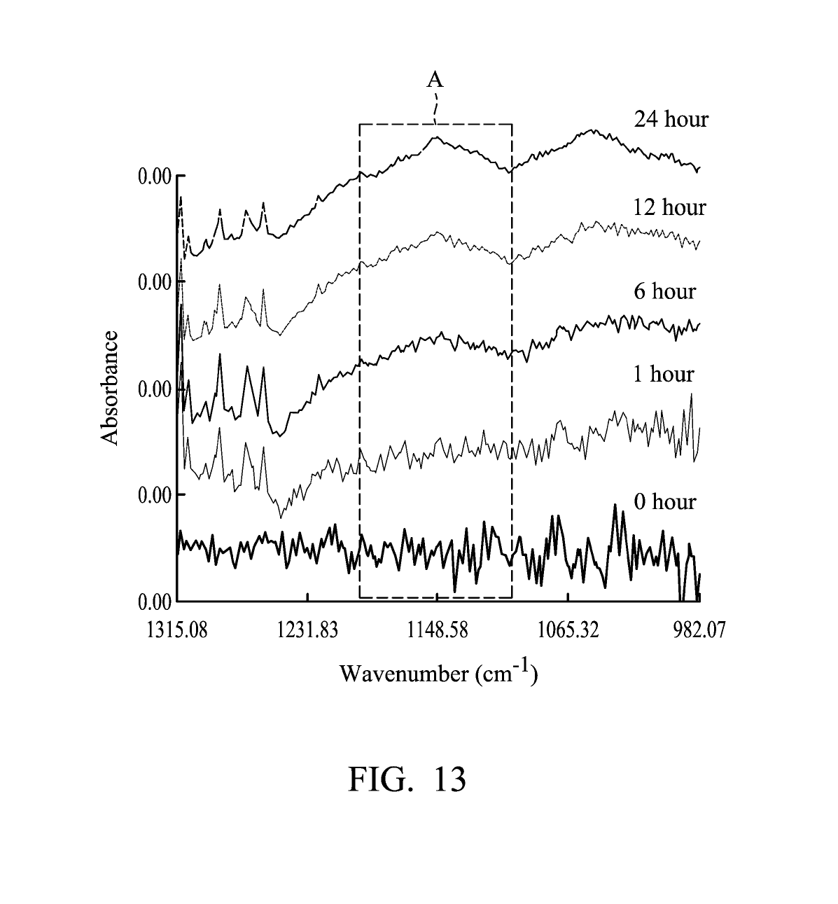

TABLE 3

| | | Total duration | | |
|---|---|---|---|---|
| | | for gas mixture | | |
| | Gas mixture | to be passed | Conc. of gas | |
| | flow rate | into the testing | to be detected | |
| Sensor material | (liters/min) | chamber (hrs) | (PH₃) | Spectra |
| Embodiment 1 | 10 | 20 | 1 ppb | FIG. 12 |
| Embodiment 1 | 10 | 24 | 500 ppt | FIG. 13 |
| Embodiment 1 | 10 | 24 | 200 ppt | FIG. 14 |

TABLE 4

| | Duration for gas mixture to be passed into the testing chamber (hrs) | | | | | | |
|---|---|---|---|---|---|---|---|
| | 0 | 4 | 7 | 8 | 10 | 12 | 24 |
| S/N | 1 | 2.20 | 2.5 | 2.92 | 3.37 | 4.09 | 7.38 |

### COMPARATIVE EXAMPLE 6

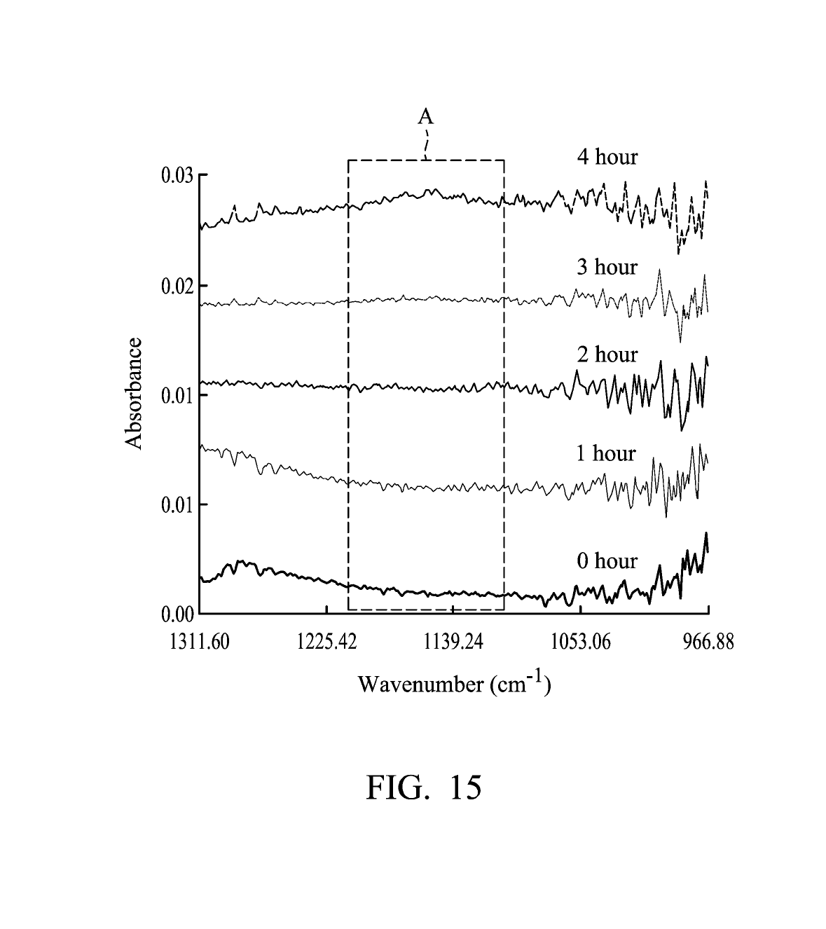

Similar processes to that of Comparative Example 5 were performed except that the sensor material was replaced with the sensor material fabricated in Comparative Example 1, and the gas mixture was fed into the testing chamber for 4 consecutive hours instead of 20 or 24 consecutive hours, and the concentration of gas to be detected (PH₃) was 100 ppb instead. The FT-IR spectrum obtained is shown in FIG. 15, and a region A as shown is the characteristic peak region for P—O bondings. After the gas mixture was fed for 4 consecutive hours, compared with in Comparative Example 5 where the sensor material could detect gas to be detected at the ppt concentration level, in Comparative Example 6, the sensor material could not even detect gas to be detected with a concentration of 100 ppb (S/N<1). This proved that the higher CuO loading (the atomic ratio of Cu/Ti was about 21%) of the sensor material fabricated by the disclosure is one of the influencing factors of whether ppt concentration level detection of gas may be achieved.

In summary, the sensor material provided by the disclosure has high metal oxide loading and dispersity and is capable of ppt concentration level detection of gas. Furthermore, the detecting method applying the aforementioned sensor material provided by the disclosure allows real time detection of gas. Therefore, the disclosure may overcome issues in prior art such as not being able to achieve ppt concentration level detection and not being able to perform detection in real time.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for fabricating a sensor material for detecting molecular contaminants, comprising the steps of:
providing an aqueous solution of a metal oxide precursor;
mixing titanium dioxide nanotubes with the aqueous solution of the metal oxide to form a mixture;
adjusting a pH value of the mixture with a weak base until the pH value is neutral;
dispersing the mixture in water and heating the mixture; and
filtering the mixture to retain a solid part, and calcining the solid part under a continuous flow of oxygen to form metal oxide loaded titanium dioxide nanotubes.

2. The method for fabricating a sensor material as claimed in claim 1, wherein the metal oxide precursor comprises Cu(NO₃)₂, HAuCl₄, AgNO₃, Fe(NO₃)₃, or combinations thereof.

3. The method for fabricating a sensor material as claimed in claim 1, wherein the metal oxide comprises CuO, AgO, Au₂O₃, Fe₂O₃, or combinations thereof.

4. The method for fabricating a sensor material as claimed in claim 1, wherein the mixing molar ratio of the titanium dioxide nanotubes to the metal oxide precursor is about 10:1 to 1:1.

5. The method for fabricating a sensor material as claimed in claim 1, wherein the weak base comprises Na₂CO₃, NH₃, C₆H₅NH₂, CH₃NH₂, CH₃CH₂NH₂, or combinations thereof.

6. The method for fabricating a sensor material as claimed in claim 1, wherein the step of dispersing the mixture in water and heating the mixture involves heating for 12-36 hours at 90-100□.

7. The method for fabricating a sensor material as claimed in claim 1, wherein the step of filtering the mixture to retain a solid part, and calcining the solid part under a continuous flow of oxygen to form metal oxide loaded titanium dioxide nanotubes comprises feeding a continuous flow of air.

8. The method for fabricating a sensor material as claimed in claim 1, wherein step of filtering the mixture to retain a solid part, and calcining the solid part under a continuous flow of oxygen to form metal oxide loaded titanium dioxide nanotubes involves calcining for 3-9 hours at 250-350° C.

9. A sensor material, comprising:
titanium nanotubes; and
metal oxide uniformly dispersed and loaded on the titanium dioxide nanotubes, wherein the metal oxide loaded titanium dioxide nanotubes have a BET of about 200-400 m²/g, and the atomic ratio of the metal in the metal oxide to titanium is about 10-50%.

10. The sensor material as claimed in claim 9, wherein the metal oxide comprises CuO, AgO, Au₂O₃, Fe₂O₃, or combinations thereof.

11. A detecting method for detecting molecular contaminants, comprising:
providing the sensor material as claimed in claim 10;
feeding a gas to react with the sensor material; and
analyzing detection results with a Raman spectroscopy system or a Fourier transform infrared spectroscopy system.

12. The detecting method as claimed in claim 11, wherein the concentration of the gas is about 5 ppm-50 ppt.

13. The detecting method as claimed in claim 11, wherein the flow rate of the gas is about 1-30 liters/minutes.

14. The detecting method as claimed in claim 11, wherein the method is for detecting a phosphor-containing compound comprising phosphine (PH₃), phosphoric acid (H₃PO₄), dimethyl methylphosphonate (DMMP), trimethyl phosphate (TMB), trimethyl phosphate (TMPO), or combinations thereof.

15. The detecting method as claimed in claim 11, wherein the method is used for detecting AsH₃, B₂H₆, di(2-ethylhexyl)phthalate (DEHP), or combinations thereof.

16. The detecting method as claimed in claim 11, wherein the method further comprises coupling the Raman spectroscopy system or the Fourier transform system with a reflective optical module with heating function.
